(19) United States
(12) Patent Application Publication
(10) Pub. No.: US 2008/0276214 A1
(43) Pub. Date: Nov. 6, 2008

(54) METHOD AND COMPUTER PROGRAM FOR AUTOMATED ASSIGNMENT AND INTERCONNECTION OF DIFFERENTIAL PAIRS WITHIN AN ELECTRONIC PACKAGE

(75) Inventors: Gerald K. Bartley, Rochester, MN (US); Darryl J. Becker, Rochester, MN (US); Paul E. Dahlen, Rochester, MN (US); Philip R. Germann, Oronoco, MN (US); Andrew B. Maki, Rochester, MN (US); Mark O. Maxson, Mantorville, MN (US)

Correspondence Address: CANTOR COLBURN LLP - IBM ROCHESTER DIVISION, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/742,970

(22) Filed: May 1, 2007

(51) Int. Cl. G06F 17/50

(52) U.S. Cl. 716/15

(57) ABSTRACT

Connection assignments of differential signals within an integrated circuit (IC) package are automatically made in the design and manufacturing process of the IC package, for use in automated computing systems. Either predefined pairs of pins at both ends or pairs of pins automatically paired or a combination of both are used in the creation of an imaginary pin or midpoint between the pair. Then the point-to-point connections of the pair are automatically detangled. Once the imaginary midpoint-to-midpoint connections are created, the real differential connections can then be assigned.

### TECHNICAL FIELD

The present invention relates generally to the design and manufacturing of integrated circuits (ICs) packages, for use in automated computing systems. More particularly, the present invention relates to the design and configuration of signal wires for differential pairs on ICs.

### BACKGROUND

Known solutions exist for routing differential wire pairs and completing pin assignments for adjacent differential wire pairs in IC packages using either manual assignments with either visual tools or with pencil and paper and then transferring the information into a visual tool. The manual assignment method can be quite time consuming and may need to be repeated for multiple iterations of the pin assignments.

In addition, manual methods for using a midpoint connection concept for detangling the wire pairs are known. However, there are no known automated methods of detangling wire pairs in regard to using a midpoint connection concept; and there are no known methods that allow various input parameters for an initial pairing algorithm.

Therefore, the need exists for an automated and less time intensive method of completing pin assignments for adjacent differential wire pairs in IC packages.

An additional need exists for providing an easier method to try multiple iterations or for quick sizings of possible differential wire pair assignments.

Further the need exists for an automated method of detangling wire pairs in regard to using a midpoint connection concept.

And, the need exists for an automated method that allows various input parameters for an initial pairing algorithm.

### SUMMARY OF THE INVENTION

A method, an automated apparatus and a program including computer readable program code are disclosed herein for assigning connections for a plurality of differential, signals between a first plurality of pins on a first component and a second plurality of pins on a second component of an IC. The method stored in the form of a segment of program code comprising a main program which is stored on a computer executable medium and includes operations and sub operations of accordingly automatically assigning a first predetermined pair of pins on the first component and automatically assigning a second predetermined pair of pins on the second component, for each differential signal in the plurality of differential signals, including inputting a list of pins selected for differential pairing and inputting pin coordinate information.

The method, includes determining if pins in the list of selected pins are paired. If it is determined that pins in list of selected pins are not paired, then running a program that pairs the pins in the list of selected pins, where pairing parameters are provided to the program as program arguments. When the program is executed in a computer, the program causes the computer to perform four sub operations of checking in a first checking sub operation for an even, number of pins to pair; checking in a second checking sub operation for any pins that cannot be paired with any other pins defined by a minimum pairing distance; selecting, in a selecting sub operation, a pin closest to one of eight points approaching infinity and a 0,0 point within an infinity box; and pairing, in a pairing sub operation, the pin selected in the selecting sub operation, with one of a possible pair of pin neighbors which have the least number of pairing opportunities. The first checking, the second checking, the selecting and the pairing sub operations are repeated until either no solution is found or all possible pairs have been identified. When no solution is found, a report is generated reporting “no solution found”. When a solution is found, the program causes the computer to create a first and second imaginary midpoints for the pin pairs.

If it is determined that pins in the list of selected pins are paired, then the method performs two creating operations. In the first creating operation, an imaginary first midpoint between a first predefined pair of pins on the first component and a second midpoint between a second predetermined pair of pins on the second component, for each differential signal on the plurality of differential signals are created. The second creating operation is that of creating a routing from the first midpoint to the second midpoint, for each differential signal in the plurality of differential signals.

In addition, the method detangles point to point crossover connections by reducing tangling between a first routing and a second routing; and reassigning the first predetermined pair of pins to a third pair of pins on the first component. This method can be reapplied for easy iterations and sizings, during early package development stages of IC packages.

### DETAILED DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings, which are meant to be exemplary, and not limiting, wherein:

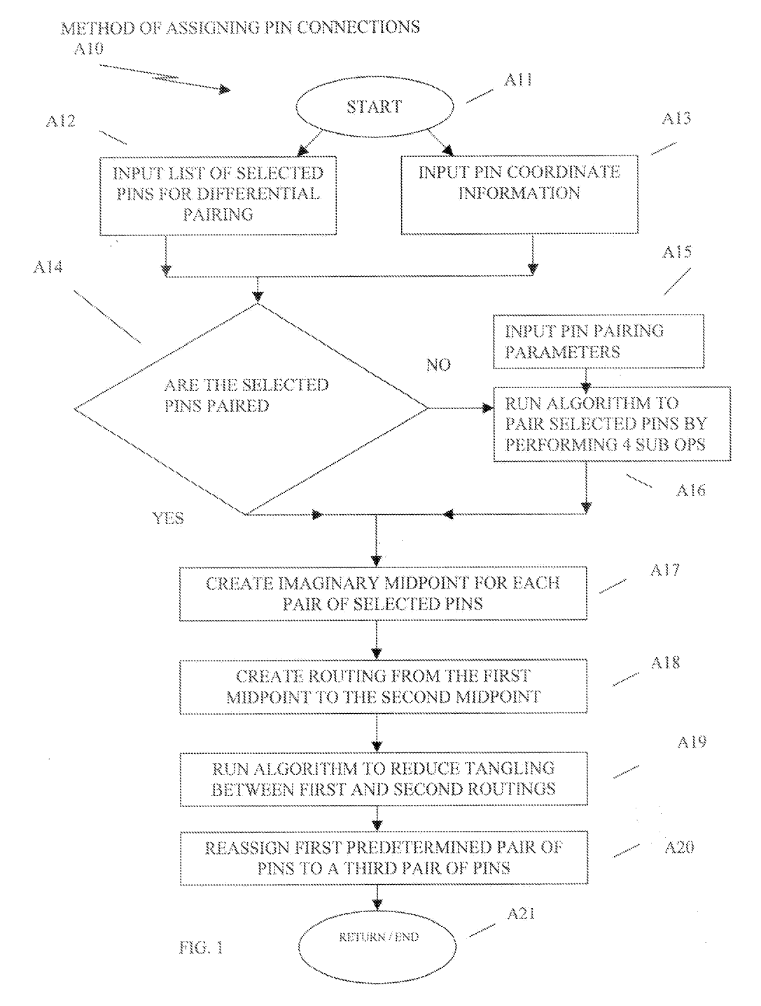

FIG. 1 illustrates a method for carrying out the operations of automated assignment and interconnection of differential pin pairs of a plurality of pins configured in a ball grid array within an electronic package.

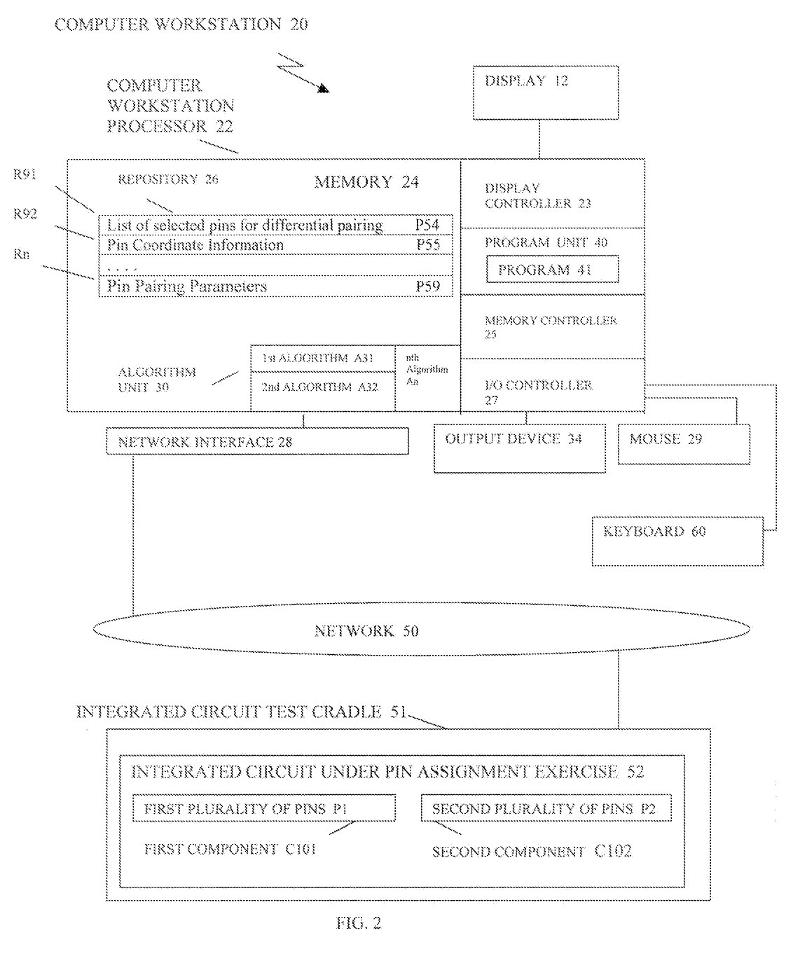

FIG. 2 illustrates a computer workstation that implements the procedure illustrated in FIG. 1.

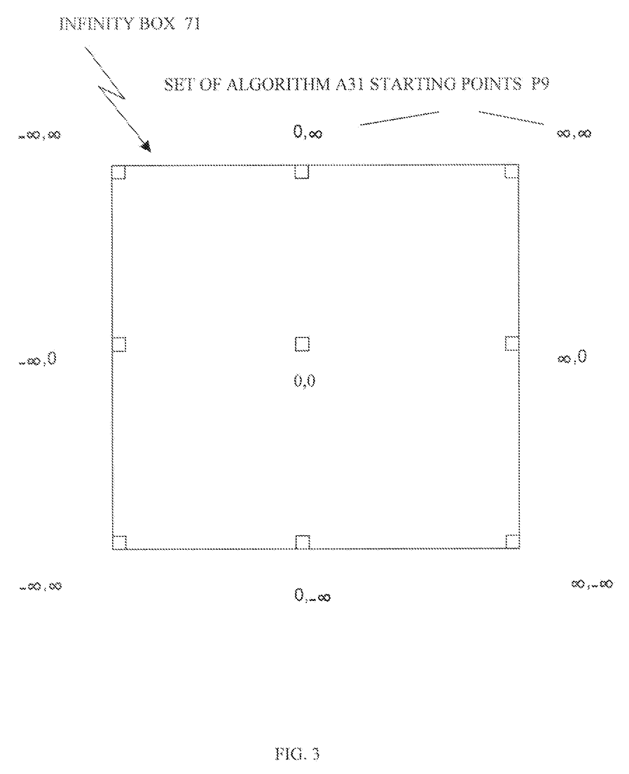

FIG. 3 illustrates an infinity box, which represents the starting points used in an algorithm for automatically pairing sets of pins of differential pin pairs.

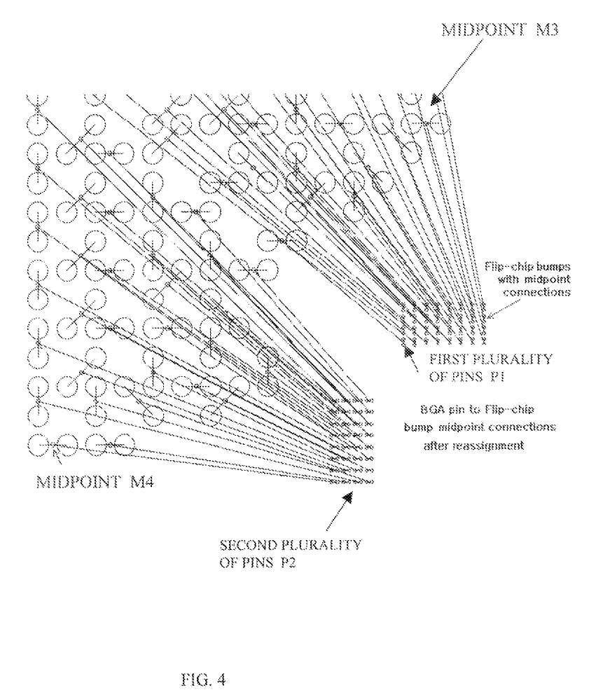

FIG. 4 illustrates an interim phase during operation A20 of FIG. 1, where midpoint connections are regrouped as pin-to-pin connections.

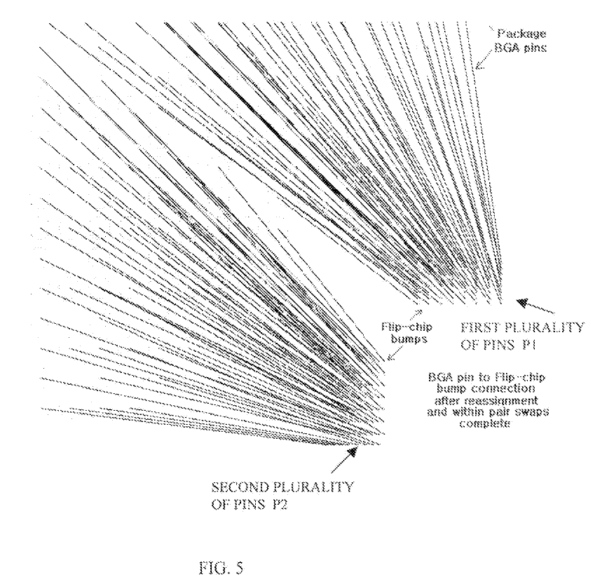

FIG. 5 illustrates pin connections alter reassigning is complete.

### DETAILED DESCRIPTION

An exemplary embodiment of a computer systems software development service offering method and system is described in detail below. The disclosed exemplary embodiment is intended to be illustrative only, since numerous modifications and variations therein will be apparent to those of ordinary skill in the art. In reference to the drawings, like numbers will indicate like parts continuously throughout the view. Further, the terms “a”, “an”, “first” and “second” herein do not denote a limitation of quantity, but rather denote the presence of one or more of the referenced item.

Referring to FIGS. 1, 2 and 3, disclosed herein are a method, an apparatus and an article of manufacture for automatically assigning pin connections. The method of assigning pin connections A10 (herein referred to as “method A10”) and an article of manufacture including a program 41 composed of computer readable program code stored on a computer executable medium, executable by a computer workstation processor 22 and when executed by computer workstation processor 22 causing computer workstation 20 to perform operations and sub operations of method A10 of assigning connections for a plurality of differential signals between a first plurality of pins P1 on a first component C101 and a second plurality of pins P2 on a second component C102. Examples of the plurality of pins P1 and P2 are illustrated in FIGS. 2 and 3. In the examples of FIGS. 2 and 3, pins are arranged in ball grid array (BGA) configurations on the first and second components C101 and C102 respectively. However, in various applications, the plurality of pins P1 and P2 can be configured in configurations other than ball grid array configurations.

Referring to FIG. 2, the apparatus upon which method A10 is implemented includes computer workstation 20, containing computer processor 22. Computer workstation 20 contains a combination of computer peripheral devices including display 12, mouse 29, keyboard 60, output device 34 and network interface 28. Network interface 28 connects to network 50, which in turn is connected to an integrated circuit test cradle 51. Integrated circuit test cradle 51 can hold integrated circuits for testing and exercising by various test and exercise programs. In the present embodiment, Integrated circuit test cradle 51, holds integrated circuit under pin assignment exercise 52 which is exercised to by program 41 to assign pin connections for the first and second plurality of pin pairs P1 and P2 respectively. In addition, computer workstation processor 22 contains a combination of controllers. The combination of controllers, residing in computer workstation processor 22, include display controller 23, memory controller 25 and input/output controller 27 (herein referred to as “I/O controller 27”). Computer workstation processor 22 also contains memory 24. Residing in memory 24 is repository 26, which contains repository entry locations R91, R92 through Rn, where the value of n is limited only by the physical size of repository 26. Repository entry location R91 can hold a list of selected pins for differential pairing P54, a set of pin coordinate information P55, and a set of pin pairing parameters P59, where the set of pin pairing parameters includes a set of algorithm A31 starting points P9, illustrated as nine points in and around Infinity box 71, where the nine points include nine sets of starting point values: 0,0; 0,∞; ∞,∞; ∞,0; ∞,−∞; 0,−∞; −∞,∞; −∞,0; and −∞,∞ (see FIG. 3). Memory 24 also includes algorithm unit 30. Residing in algorithm 30 is a plurality of algorithms from a first algorithm A31, a second algorithm A32 up to an nth algorithm An. Each algorithm in the plurality of algorithms A31, A32 up to An can be called by program 41 to perform an operation or sub operation of the method A10. In addition, computer workstation processor 22 contains program unit 40 which in turn contains program 41, which, as discussed above, when executed by computer workstation processor 22 causes computer workstation 20 to perform the operations and sub operations of method A10.

Method A10 includes the operations of assigning a first predetermined pair of pins P1 on the first component C101 and assigning a second predetermined pair of pins P2 on the second component C102, for each differential signal in the plurality of differential signals, where program 41 prompts via display 12 for input of a list of pins selected for differential pairing P54 and also prompts for input of pin coordinate information P55, where, once entered into entry locations R91, R92, algorithms from the plurality of algorithms A31, A32 up to An are called to retrieve the list of pins selected for differential pairing P54 and the pin coordinate information P55 for use in operations and sub operations performed by program 41 in carrying out method A10.

The method A10 includes determining at operation A14 if pins in the list of selected pins are paired. If it is determined by program 41 at operation A14 that the pins in the list of selected pins are not paired (NO), then program 41 calls first algorithm A31 which when executed and running, pairs the pins in the list of selected pins for differential pairing P54 at operation A16, based on pairing parameters inputted at operation A15 as a set of arguments for first algorithm A31. If is determined by program 41 at operation A14 that the pins in the list of selected pins are paired (YES), then method A10 performs two creating operations A17 and A18. In the first creating operation A17, an imaginary first midpoint M3 between a first predefined pair of pins on the first component and an imaginary second midpoint M4 between the second predetermined pair of pins on the second component, for each differential signal in the plurality of differential signals. The second creating operation A18 is that of creating a routing from the imaginary first midpoint M3 to the second imaginary midpoint M4, for each differential signal in the plurality of differential signals.

When program 41 of method A10 calls for first algorithm A31 to run, which pairs pins in the list of selected pins at operation A16, program code of first algorithm A31 when executed by a computer workstation 22 causes the computer workstation 20 to perform four sub operations (herein referred to as “4 sub ops”) of checking in a first checking sub operation for an even number of pins to pair; checking in a second checking sub operation for any pins that cannot be paired with any other pins defined by a minimum pairing distance; selecting, in a selecting sub operation, a pin closest to one of eight points approaching infinity and a 0,0 point (i.e., the nine sets of starting point values) within infinity box 71; and pairing, in a pairing sub operation, the selected pin selected in the selecting sub operation, with one of a possible pair of pin neighbors which have the least number of pairing opportunities, where the first checking, the second checking, the selecting and the pairing sub operations are repeated until either all possible pairs have been identified or no solution is found. If no solution is found a report is generated indicating “no solution found” and output to display 12 and/or output device 34. If a solution is found, then as discussed above, method A10 creates the first and second imaginary midpoints for the pin pairs at operation A17.

In addition, method A10 detangles point to point crossover connections by running a program to reducing tangling between a first routing and a second routing at operation A19, and at operation A20, method A10 reassigns the first predetermined pair of pins to a third pair of pins on the first component. At return/end operation A21, method A10 can be reapplied for easy iterations and sizings, during early package development stages of IC packages or method A10 can end at return/end operation A21.

While the disclosure has been described with reference to an exemplary embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not he limited to the particular exemplary embodiment disclosed as the best mode contemplated for carrying out this disclosure, but that the disclosure will include all embodiments falling within the scope of the appended claims.

What is claimed is:

1. A method for automatically assigning connections for a plurality of differential signals between a first plurality of pins on a first component and a second plurality of plus on a second component of an integrated circuit, the method comprising:
assigning a first predetermined pair of pins on the first component and assigning a second predetermined pair of pins on the second component, for each differential signal in the plurality of differential signals, by inputting a list of pins selected for differential pairing and inputting pin coordinate information;
determining if pins in the list of pins selected are paired and performing one of calling in a first calling operation a first by a main program that when executed, pairs pins in the list of selected pins, where pairing parameters are provided to a first algorithm as program arguments, if pins in the list of selected pins are not paired and creating, in a first creating operation, an imaginary first midpoint between the first predetermined pair of pins on the first component and an imaginary second midpoint between the second predetermined pair of pins on the second component, for each differential signal in the plurality of differential signals, if pins in the list of selected pins are paired, and wherein execution of the first algorithm that automatically pairs pins in the list of selected pins performs four sub operations:
checking in a first checking sub operation for an even number of pins to pair;
checking in a second checking sub operation for any pins that cannot be paired with any other pins defined by a minimum pairing distance;
selecting, in a selecting sub operation, a pin closest to one of eight points approaching infinity and a 0,0 point within an infinity box; and
pairing, in a pairing sub operation, a pin selected in the selecting sub operation, with one of a possible pair neighbors which has a least number of pairing opportunities, where the first checking, the second checking, the selecting and the pairing sub operations are repeated until one of all possible pairs have been identified and no solution is found, where a report is generated reporting no solution found, if no solution is found, and where a solution is found, creating the first and second imaginary midpoints for pin paired;
creating, in a second creating operation, a routing from the imaginary first midpoint to the imaginary second midpoint, for each differential signal in the plurality of differential signals;
calling in a second calling operation a second algorithm that performs a reducing operation that reduces tangling of crossover connections between a first routing and a second routing; and
reassigning in a reassigning operation the first predetermined pair of pins to a third pair of pins on the first component.

2. The method for automatically assigning connections, according to claim 1, further comprising performing one of returning and ending, where returning causes the method lot assigning connections to repeat one of assigning, determining, the first creating, the second creating, reducing and reassigning, for automatic iterations and sizings, during early package development stages.

3. The method for automatically assigning connections, according to claim 2, where the first and second plurality of pins are arranged in a ball grid array configuration.

4. An automated apparatus for automatically assigning connections for a plurality of differential signals between a first plurality of pins on a first component and a second plurality of pins on a second component of an integrated circuit, the automated apparatus comprising:
a computer workstation containing a computer workstation processor;
a combination of computer peripheral devices connected to the computer workstation, where the combination of computer peripheral devices includes a display, a set of input devices including a keyboard and a mouse, an output device, and a network interface, where the network interface connects to a network, where the network is connected to an integrated circuit test cradle containing an integrated circuit under pin assignment exercise, and where the integrated circuit contains tie first component with the first plurality of pins and the second component with the second plurality of pins;
a combination of controllers residing in the computer workstation, where the combination of controllers include a display controller, a memory controller and an input/output controller;
a memory, a program unit and an algorithm unit residing in the computer workstation processor, where the memory contains a repository with repository entry locations, the algorithm unit contains a plurality of algorithms and the program unit contains a program, that when executed by the computer workstation processor, causes the computer workstation processor to:
assign in a first assigning operation a first predetermined pair of pins on the first component and assign in a second assigning operation a second predetermined pair of pins on the second component, for each differential signal in the plurality of differential signals, by inputting a list of selected pins selected for differential pairing and inputting pin coordinate information;
determine in a determining operation if pins in the list of selected pins are paired and performing one of calling in a first calling operation a first algorithm by the program that when executed, pairs pins in the list of selected pins, where pairing parameters are provided to the first algorithm as program arguments, if pins in the list of selected pins are not paired and creating, in a first creating operation, an imaginary first midpoint between the first predetermined pair of pins on the first component and an imaginary second midpoint between the second predetermined pair of pins on the second component for each differential signal in the plurality of differential signals, if pins in the list of pins are paired, and wherein execution of the first algorithm that automatically pairs pins in the list of selected pins performs four sub operations to;
check in a first checking sub operation for an even number of pins to pair;
cheek in a second checking sub operation for any pins that cannot be paired with any other pins defined by a minimum pairing distance;
select, in a selecting sub operation, a pin closest to one of eight points approaching infinity and a 0,0 point within an infinity box; and
pair, in a pairing sub operation, a pin selected in the selecting sub operation, with one of a possible pair neighbors which has a least number of pairing opportunities, where the first checking, the second checking, the selecting and the pairing sub operations are repeated until one of all possible pairs have been identified and; no solution is found, where a report is generated reporting no solution found, if no solution is found, and where a solution is found, creating the first and second imaginary midpoints for pin paired;
create, in a second creating operation, a routing from the imaginary first midpoint to the imaginary second midpoint, for each differential signal in the plurality of differential signals;
call in a second calling operation a second algorithm that performs a reducing operation that reduces tangling of crossover connections between a first routing and a second routing;
reassign in a reassigning operation the first predetermined pair of pins to a third pair of pins on the first component; and
perform one of returning and ending, where returning causes the method for automatically assigning connections to repeat one of assigning, determining, the first creating, the second creating, reducing and reassigning, for automatic iterations and sizings, during early package development stages.

5. The automated apparatus according to claim 4, where the first and second plurality of pins are arranged in a ball grid array configuration.

6. An article of manufacture comprising a computer executable medium including a segment of computer readable program code stored on the computer executable medium executed on a computer workstation processor for automatically assigning connections for a plurality of differential signals between a first plurality of pins on a first component and a second plurality of pins on a second component of an integrated circuit, the article of manufacture comprising;
the segment of computer readable program code stored on the computer executable medium, when executed by the computer workstation processor causing a computer workstation to perform an operation of automatically assigning a first predetermined pair of pins of the first plurality of pins on the first component and an operation of automatically assigning a second predetermined pair of pins of the second plurality of pins on the second component, for each differential signal in the plurality of differential signals, by inputting a list of selected pins for differential pairing and inputting pin coordinate information;
the segment of computer readable program code when executed by the computer workstation processor causing the computer workstation to perform an operation of determining if pins in the list of selected pins are paired and perform one of calling in a first calling operation and executing an algorithm that pairs pins in the list of selected pins, where pairing parameters are provided to the algorithm that pairs pins as program arguments, if pins in the list of selected pins are not paired and creating, in a first creating operation, an imaginary first midpoint between the first predetermined pair of pins on the first component and an imaginary second midpoint between the second predetermined pair of pins on the second component, for each differential signal in the plurality of differential signals, if pins in the list of selected pins are paired, and wherein executing the algorithm mat pairs pins in the list of selected pins performs four sub operations to:
check in a first checking sub operation for an even number of pins to pair;
check in a second checking sub operation for any pins that cannot be paired with any other pins defined by a minimum pairing distance;
select, in a selecting sub operation, a pin closest to one of eight points approaching infinity and a 0,0 point within an infinity box; and
pair, in a pairing sub operation, a pin selected in the selecting sub operation, with one of a possible pair neighbors which has a least number of pairing opportunities, where the first checking, the second checking, the selecting and the pairing sub operations are repeated until one of all possible pairs have been identified and no solution is found, where a report is generated reporting no solution found, if no solution is found, and where a solution is found, creating the first and second imaginary midpoints for pin paired;
the segment of computer readable program code, when executed by the computer workstation processor causing the computer workstation to perform a second creating operation, a routing from the imaginary first midpoint to the imaginary second midpoint, for each differential signal in the plurality of differential signals;
the segment of computer readable program code when executed by the computer workstation processor causing the computer workstation to perform an operation of reducing tangling between a first routing and a second routing; and
the segment of computer readable program code when executed by the computer workstation processor causing the computer workstation to perform an operation of reassigning the first predetermined pair of pins to a third pair of pins on the first component; and
the segment of computer readable program code when executed by the computer workstation processor causing the computer workstation to perform an operation of performing one of returning and ending, where returning causes the method for assigning connections to repeal one of assigning, determining, the first creating, the second creating, reducing and reassigning, for automatic iterations and sizings, during early package development stages.
